(19) United States
(12) Patent Application Publication
(10) Pub. No.: US 2025/0188564 A1
(43) Pub. Date: Jun. 12, 2025

(54) Method for the Elution of Aluminum Ions and/or Zinc Ions

(71) Applicant: LANXESS Deutschland GmbH, Cologne (DE)

(72) Inventors: Stefan Neufeind, Siegburg (DE); Dirk Steinhilber, Neuss (DE); Joachim Kralik, Leichlingen (DE); Pavlos Makropoulos, Leverkusen (DE)

(73) Assignee: LANXESS Deutschland GmbH, Cologne (DE)

(21) Appl. No.: 18/847,523

(22) PCT Filed: Mar. 16, 2023
(86) PCT No.: PCT/EP2023/056774

§ 371 Date: Sep. 16, 2024

(30) Foreign Application Priority Data
Mar. 22, 2022 (EP) 22163466.0

(51) Int. Cl. C22B 3/42; C22B 3/00; C22B 21/00; H01M 10/54

(52) U.S. Cl. CPC C22B 3/42; C22B 19/26; C22B 21/0023; H01M 10/54

(57) ABSTRACT

The present invention relates to a method for the elution of aluminum ions and/or zinc ions of polymers containing aminomethylphosphonic acid groups.

The present invention relates to a process for the elution of aluminum ions and/or zinc ions from aminomethylphosphonic acid group-containing polymers.

The recycling of lithium-ion batteries is a critical technology in order to enable the transformation to more sustainable electromobility. Ion exchangers represent a promising technology for removing impurities such as copper, aluminum and zinc from electrolyte concentrates produced from recycled lithium-ion batteries. The use of phosphonate group-containing polymers is known for example from WO-A 2012/113657 to be particularly suitable for removing divalent and trivalent metal ions. It is also known from WO-A 2012/113657 that the phosphonate group-containing polymers can be regenerated by use of an alkaline solution containing tartrate, citrate, oxalate or EDTA ions and in so doing the metal ions are removed from the polymers.

Virolainen et al. (S. Virolainen, T. Vesselborg, A. Kaukinen, T. Sainio, Hydrometallurgy 2021, 202, 105602, p. 1 to 9) describe that aminomethylphosphonic acid group-containing polymers, such as Lewatit® MDS TP 260, are particularly suitable for removing aluminum and iron from a mixture of aluminum, copper, manganese, iron, lithium, nickel and cobalt concentrates. For this purpose, Virolainen et al. developed a two-stage process in which the metal ions are initially bound to the aminomethylphosphonic acid group-containing polymer and then, in a first step, copper, manganese and cobalt are eluted with sulfuric acid, the cobalt solution is adsorbed again and in a second step the aluminum is complexed and eluted with an alkaline potassium oxalate solution.

The elution processes known from the prior art for eluting aluminum ions and/or zinc ions on aminomethylphosphonic acid group-containing polymers provide for the use of complexing agents, since the binding affinity of aluminum ions and zinc ions to the phosphonic acid groups is very high. However, complexing agents are compounds that pollute the wastewater, i.e. have ecological disadvantages, and therefore have to be removed from it again. This in turn increases the costs of the process.

There was therefore still a need for a process with which aluminum ions and/or zinc ions can be eluted from aminomethylphosphonic acid group-containing polymers with high selectivity.

It has now surprisingly been found that aluminum ions and/or zinc ions can be eluted from aminomethylphosphonic acid group-containing polymers with high selectivity if the base used for elution is a base selected from the group of alkali metal hydroxides and ammonium hydroxide or mixtures of these bases.

The present invention therefore provides a process for the elution of aluminum ions and/or zinc ions, in which aminomethylphosphonic acid group-containing polymer, or salts thereof, at least partially laden with aluminum ions and/or zinc ions is admixed with a base selected from the group of alkali metal hydroxides and ammonium hydroxide or mixtures of these bases and the aluminum ions and/or zinc ions are eluted.

The scope of the invention encompasses all definitions of radicals, parameters and elucidations above and detailed hereinafter, in general terms or mentioned within preferred ranges, together with one another, i.e. including any combination between the respective ranges and preferred ranges.

Aminomethylphosphonic acid group-containing polymers are preferably aminomethylphosphonic acid group-containing polystyrene copolymers. Even further preference is given to aminomethylphosphonic acid group-containing polymers aminomethylphosphonic acid group-containing polystyrene-divinylbenzene copolymers.

Aminomethylphosphonic acid group-containing polymers include aminomethylmonophosphonic acid group-containing polymers, aminomethyldiphosphonic acid group-containing polymers, and salts thereof. Salts of the aminomethylphosphonic acid group-containing polymers are preferably alkali metal salts, alkaline earth metal salts and metal salts of groups III to XII of the Periodic Table of the Elements. Salts of the aminomethylphosphonic acid group-containing polymers are preferably sodium, potassium, lithium, magnesium, calcium, iron, copper, manganese, cobalt and nickel salts. Salts of aminomethylphosphonic acid group-containing polymers may particularly preferably be the sodium, potassium, lithium, cobalt and nickel salts thereof. Particular preference is given to using sodium, potassium or nickel salts as salts of the aminomethylphosphonic acid group-containing polymers.

Polystyrene copolymers used are preferably copolymers of monovinylaromatic monomers selected from the group of styrene, vinyltoluene, ethylstyrene, α-methylstyrene, chlorostyrene or chloromethylstyrene and mixtures of these monomers with polyvinylaromatic compounds (crosslinkers) selected from the group of divinylbenzene, divinyltoluene, trivinylbenzene, divinylnaphthalene and/or trivinylnaphthalene.

The polystyrene copolymer skeleton used is particularly preferably a styrene/divinylbenzene copolymer. A styrene/divinylbenzene copolymer is a copolymer crosslinked using divinylbenzene. Preference is given to using technical grade divinylbenzene, which can contain up to 30% by weight of ethylvinylbenzene. The styrene/divinylbenzene copolymer therefore also includes copolymers which additionally also contain ethylvinylbenzene as monomer.

The polymer preferably has a spherical form.

The aminomethylphosphonic acid group-containing polymers preferably have a macroporous structure.

The terms “microporous” or “in gel form”/“macroporous” have already been described in detail in the technical literature, for example in Seidl, Malinsky, Dusek, Heitz, Adv. Polymer Sci., 1967, Vol. 5, pp. 113 to 213. The possible methods of measurement for macroporosity, for example mercury porosimetry and BET determination, are likewise described in said document. The pores of the macroporous polymers of the aminomethylphosphonic acid group-containing polymers generally and preferably have a diameter of 20 nm to 100 nm.

The aminomethylphosphonic acid group-containing polymers preferably have a monodisperse distribution.

In the present application, monodisperse materials are those in which at least 90% by volume or 90% by mass of the particles have a diameter within the interval of ±10% of the most common diameter.

For example, in the case of a material having a most common diameter of 0.5 mm, at least 90% by volume or 90% by mass is within a size interval between 0.45 mm and 0.55 mm; in the case of a material having a most common diameter of 0.7 mm, at least 90% by volume or 90% by mass is within a size interval between 0.77 mm and 0.63 mm.

The aminomethylphosphonic acid group-containing polymer preferably has a diameter (d₅₀) of 200 to 1500 μm.

Very particularly preferably, it has a diameter (d₅₀) of 250 μm to 450 μm.

Aminomethylphosphonic acid group-containing polymers may be produced according to known processes, for example by phthalamidomethylation of a styrene-divinylbenzene copolymer and functionalization of the resulting amino groups by reaction of P—H acidic compounds in sulfuric acid-containing suspension with formalin. They are also commercially available, for example as Lewatit® MDS TP 260 from LANXESS Deutschland GmbH.

The average degree of substitution indicates the statistical ratio between aminomethyl groups that are unsubstituted, monosubstituted by phosphonic acid groups and disubstituted by phosphonic acid groups in the aminomethylphosphonic acid group-containing polymers. The average degree of substitution may therefore be between 0 and 2. At a degree of substitution of 0, no substitution would have taken place and the aminomethyl groups would be present as primary amine groups. At a degree of substitution of 2, all aminomethyl groups in the resin would be present disubstituted by phosphonic acid groups. At a degree of substitution of 1, all aminomethyl groups in the resin would be present in monosubstituted form from a statistical viewpoint.

The average degree of substitution of the aminomethyl groups by phosphonic acid groups in the aminomethylphosphonic acid group-containing polymers is preferably 1.4 to 2.0.

Preferably, the aminomethylphosphonic acid group-containing polymers have a total hydrogen capacity of 2.5 mol/l to 7.0 mol/l of resin. Very particularly preferably, the aminomethylphosphonic acid group-containing polymers have a total hydrogen capacity of 3.0 to 3.4 mol/l of resin.

The total capacity of the aminomethylphosphonic acid group-containing polymers is determined in accordance with DIN 54403 (Testing of ion exchangers-Determination of the total capacity of cation exchangers).

Used as aminomethylphosphonic acid group-containing polymer are preferably chelating resins containing functional groups of structural element (I)

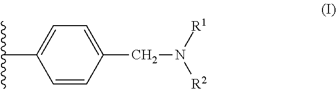

in which [symbol] is the polystyrene copolymer skeleton and

R¹ and R² may be identical and different and are independently —CH₂PO(OX¹)² and —CH₂PO(OH)OX² or hydrogen, where R¹ and R² may not both simultaneously be hydrogen and X¹ and X² are independently hydrogen, sodium, potassium or lithium.

Preferably, R¹ and R² are independently —CH₂PO(OX¹)₂ and —CH₂PO(OH)OX₂. Preferably, X¹ and X²=H.

In the polystyrene copolymer skeleton, the —CH₂—NR¹R² group is bonded to a phenyl radical.

Aminomethylphosphonic acid group-containing polymers are preferably macroporous, monodisperse chelating resins containing functional groups of structural element (I).

The aminomethylphosphonic acid group-containing polymers may be partially or completely laden with aluminum ions and/or zinc ions.

Preferably, the aminomethylphosphonic acid group-containing polymer is laden with aluminum ions and/or zinc ions to an extent of 10 mol % to 90 mol % based on the total capacity of the polymer.

Alkali metal hydroxides used are preferably sodium hydroxide and potassium hydroxide. The alkali metal hydroxides are preferably present in an aqueous solution.

The alkali metal hydroxide solution preferably contains between 5% by weight and 20% by weight of alkali metal hydroxides. Particularly preferably, the alkali metal hydroxide solution contains 6% by weight to 12% by weight of alkali metal hydroxide.

In a further preferred embodiment, the alkali metal hydroxide solution contains 5% by weight to 20% by weight of alkali metal hydroxide and 79% by weight to 94% by weight of water and up to 1% by weight of organic solvent or other impurities, such as alkaline earth metal hydroxides or potassium oxalate. Should potassium oxalate be present, then in every case the proportion is <0.1% by weight.

In a further preferred embodiment, the alkali metal hydroxide solution contains 6% by weight to 12% by weight of alkali metal hydroxide and 87% by weight to 93% by weight of water, it being possible for up to 1% by weight of organic solvent or other impurities, such as alkaline earth metal hydroxides or potassium oxalate, to be present. Should potassium oxalate be present, then in every case the proportion is <0.1% by weight.

In a further preferred embodiment, the alkali metal hydroxide solution consists of 5% by weight to 20% by weight of alkali metal hydroxide and 80% by weight to 95% by weight of water and the sum total of these compounds amounts to 100% by weight.

Solutions of ammonia in water at a concentration between 15% by weight and 35% by weight are preferably used as ammonium hydroxide.

In a further preferred embodiment, the ammonium hydroxide solution contains 15% by weight to 35% by weight of alkali metal hydroxide and 84% by weight to 64% by weight of water, it being possible for up to 1% by weight of organic solvent or other impurities, such as alkaline earth metal hydroxides or potassium oxalate, to be present. Should potassium oxalate be present, then in every case the proportion is <0.1% by weight.

In a further preferred embodiment, the bases used do not contain any complexing agents. In the context of the invention, complexing agents are preferably solutions containing tartrate, citrate, oxalate or EDTA ions. Even further preferably, the base contains no oxalate ion, in particular no potassium oxalate.

The elution may be performed in a batch process or by application to a column. The amount of base that has to be applied for elution is preferably 1 to 10 bed volumes of polymer, particularly preferably 3 to 7 bed volumes of polymer.

In the elution, the pH of the eluate is preferably 10 to 14.

The elution is preferably performed at temperatures of 60° C. to 90° C. In order to achieve this temperature, the base may be heated or the aminomethylphosphonic acid group-containing polymer may be heated in a column process, for example and preferably, by a heating coil.

After the elution, the aminomethylphosphonic acid group-containing polymer may be regenerated again by being brought into contact with an acid. In this step, on the one hand impurities are removed, but on the other hand the aminomethylphosphonic acid group-containing polymer is also converted back into the H form. This allows the resin to be loaded with metal ions again. Inorganic acids are preferably used as acids to regenerate the aminomethylphosphonic acid group-containing polymer. Inorganic acids used are preferably sulfuric acid, hydrochloric acid and nitric acid. Particularly preferably, sulfuric acid is used to regenerate the aminomethylphosphonic acid group-containing polymer.

Preferably, the sulfuric acid is used at a concentration of 5% by weight to 20% by weight to regenerate the aminomethylphosphonic acid group-containing polymer.

In a further preferred embodiment, the invention encompasses a process for the elution of aluminum ions and/or zinc ions, in which at least one chelating resin containing functional groups of structural element (I)

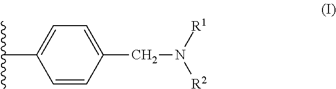

in which [symbol] is the polystyrene copolymer skeleton and

R¹ and R² may be identical and different and are independently —CH₂PO(OX¹)₂ and —CH₂PO(OH)OX² or hydrogen, where R¹ and R² may not both simultaneously be hydrogen and X¹ and X² are independently hydrogen, sodium, potassium and lithium

in a step a.) is brought into contact with an aqueous metal ion solution containing aluminum ions and/or zinc ions and optionally further metal ions with the chelating resin and

in a step b.) the aluminum ions and/or zinc ions are eluted with an aqueous alkali metal hydroxide solution or ammonium hydroxide solution or mixtures of these bases.

### Step a.)

The metal ions and/or aluminum ions and/or zinc ions are brought into contact in an aqueous metal ion solution with the chelating resin containing functional groups of structural element (I). The metal adsorption may be performed in a batch process or by application to a column. The adsorption is preferably performed in a column process.

In step a.), it is possible to use aluminum ions and/or zinc ions at a concentration of 10 μg/l to 5 g/l. Preference is given to using aluminum ions and/or zinc ions at a concentration of 1 mg/l to 1 g/l. The chelating resin containing functional groups of structural element (I) may be brought into contact and thus loaded with further metal ions. The ions of the metals iron, copper, manganese, cobalt, nickel and lithium may preferably be used as metal ions. Divalent or trivalent iron ions are preferably used. Divalent copper, manganese, cobalt and/or nickel ions are preferably used. Trivalent aluminum ions are preferably used. Divalent zinc ions are preferably used. Lithium, nickel and cobalt ions may particularly preferably be used. Even further preference is given to using nickel and cobalt ions.

Preferably, an aqueous metal ion solution of aluminum ions, nickel ions and cobalt ions is applied to the chelating resin in step a.).

Preferably, the molar ratio of the aluminum ions to the nickel ions and/or the cobalt ions in step a.) in the application is 0.5 to 1.5.

The ratio of the weight concentration of the metal ions to the aluminum ions and/or zinc ions in step a.) in the chelating resin is preferably 100:1 to 2:1.

The ratio of the weight concentration of the lithium ions to the aluminum ions and/or zinc ions in step a.) in the chelating resin is preferably 100:1 to 2:1.

The ratio of the weight concentration of the cobalt ions to the aluminum ions and/or zinc ions in step a.) in the chelating resin is preferably 100:1 to 2:1.

The ratio of the weight concentration of the manganese ions to the aluminum ions and/or zinc ions in step a.) in the chelating resin is preferably 100:1 to 2:1.

The ratio of the weight concentration of the copper ions to the aluminum ions and/or zinc ions in step a.) in the chelating resin is preferably 100:1 to 2:1.

The ratio of the weight concentration of the iron ions to the aluminum ions and/or zinc ions in step a.) in the chelating resin is preferably 100:1 to 2:1.

The ratio of the weight concentration of the nickel ions to the aluminum ions and/or zinc ions in step a.) in the chelating resin is preferably 100:1 to 2:1.

Preferably, an inorganic metal salt solution is used as aqueous metal ion solution in step a.). Inorganic metal salts used are particularly preferably nitrates, chlorides or sulfates. Very particular preference is given to using metal sulfates. Cobalt (II) sulfate, nickel (II) sulfate and aluminum (III) sulfate are preferably used.

In a further preferred embodiment, in step a.) the chelating resin containing functional groups of structural element (I) is loaded with aluminum ions that may contain further metal ions, but zinc ions are not present.

Chelating resins containing functional groups of structural element (I) having a specific flow rate of 2 to 10 bed volumes per hour (BV/h) are preferably used in step a.).

Preferably, in step a.) 0.5 to 1.5 equivalents (Eq) of chelating resins containing functional groups of structural element (I) are used per equivalent (Eq) of aluminum ions and/or zinc ions.

The chelating resins containing functional groups of structural element (I) are preferably loaded with metal ions in step a.) at a pH of 1.5 to 6.0. Since the metal ions used constitute Lewis acids, this pH is often already present in the aqueous solution used. Should the pH not be present, it is possible to adjust the pH using an acid, preferably an inorganic acid. Use is preferably made of sulfuric acid, hydrochloric acid or nitric acid for this purpose. Particular preference is given to using sulfuric acid.

### Step b.)

In step b.), the aluminum ions and/or zinc ions are eluted from the chelating resin containing functional groups of structural element (I). Trivalent aluminum ions are preferably used in step a.) and eluted in step b.). Divalent zinc ions are preferably used in step a.) and eluted in step b.). The elution is preferably performed using an alkali metal hydroxide solution. Aluminum ions are preferably eluted in step b.).

The process according to the invention, in which alkali metal and/or ammonium hydroxide solutions are used for the selective removal of aluminum ions and/or zinc ions from aminomethylphosphonic acid group-containing polymers and/or chelating resins containing functional groups of structural element (I), has created a way to selectively process metal-containing lithium waste from used batteries.

### Methods

### ICP

The ion concentration can be determined by processes known to those skilled in the art from the prior art. The ion concentration is preferably determined in the process according to the invention by means of an inductively coupled plasma spectrometer (ICP).

The mobile phase from the ion exchanger column was in this case fractionated into 10 ml fractions and analyzed by means of ICP and the ion concentration determined.

### Determination of Total Capacity

The total capacity of the chelating resins containing functional groups of structural element (I) is determined in accordance with DIN 54403 (Testing of ion exchangers-Determination of the total capacity of cation exchangers).

### Determination of the Diameter of the Polymers

The diameter of the polymers is determined in accordance with DIN 54407: Testing of ion exchange resins-Determination of bead size distribution. The diameter d50 here is the diameter of the polymers or of the polymer particles at which 50% of the polymers fall through a sieve with a mesh size of 0.5 mm and 50% remain.

### EXAMPLES

### Example 1

A. Loading of a Macroporous, Monodisperse Chelating Resin Containing Functional Groups of Structural Element (I) with Aluminum, Nickel and Cobalt

200 ml of the chelating resins containing functional groups of structural element (I) where R¹ and R² are independently —CH₂PO(OX¹)₂ and —CH₂PO(OH)OX², where X¹ and X²=H (Lewatit® MDS TP 260, degree of substitution of the aminomethyl groups by phosphonic acid groups=2.0, total capacity 3.2 mol/l, H form, d₅₀ 0.385 mm, monodisperse and macroporous), in the H form is dispersed in demineralized water and adjusted to pH=4 with H₂SO₄ in a beaker with stirring. This is followed by the gradual addition of 250 ml of an aqueous Co²⁺/Ni²⁺/Al³⁺ sulfate solution with 6.95 g (0.118 mol/0.027 g/l) of cobalt, 6.93 g (0.118 mol) of nickel and 3.20 g (0.118 mol) of aluminum with stirring. The pH fell from 4.0 to 1.9 in the supernatant of the ion exchanger during the addition of the solution. The supernatant solution is then completely decanted off and volumetrically measured. The chelating resin is washed several times with demineralized water and subjected to suction in order to remove adhering Co, Ni, Al (850 ml of washing water). The loading capacity of the chelating resin containing functional groups of structural element (I) was calculated by the decrease of Al, Ni and Co in the supernatant and is 10.9 g/l (0.4 mol/l) for Al, 0.8 g/l (0.0135 mol/l) for Ni and 1.1 g/l (0.0135 mol/l) for Co. 37.8% of the total capacity of the resin was loaded with aluminum ions.

B. Selective Aluminum Elution with NaOH and Regeneration by Way of Diluted Sulfuric Acid

In the next step, 20 ml of chelating resin containing functional groups of structural element (I) from A is eluted with 100 ml of aqueous NaOH 9% by weight over the course of 3 hours at 80° C. with stirring. The alkaline solution is then decanted off. Following this, some of the completely regenerated resin is dried and digested in a microwave. The aluminum, nickel and cobalt concentration is determined by means of ICP (inductively coupled plasma spectrometer). The aluminum concentration is below the detection limit. The nickel and cobalt concentration on the chelating resin containing functional groups of structural element (I) remain unchanged within the scope of the detection limits. The remaining chelating resin is washed thoroughly and regenerated with 100 ml of H₂SO₄ 15% by weight at room temperature with stirring over the course of 1 hour. After a washing step with 80 ml of deionized water, the supernatant NaOH was removed. The nickel and cobalt that remained on the ion exchanger was eluted within the scope of the detection limits to an extent of virtually 100% by weight by the addition of 15% by weight of H₂SO₄.

1. A process for elution of aluminum ions and/or zinc ions, comprising the steps of
admixing an aminomethylphosphonic acid group-containing polymer, or a salt thereof, at least partially laden with aluminum ions and/or zinc ions with a base selected from the group of consisting of alkali metal hydroxides, ammonium hydroxide, and mixtures thereof; and
eluting the aluminum ions and/or zinc ions with a solution.

2. The process as claimed in claim 1, wherein aminomethylphosphonic acid group-containing polystyrene-divinylbenzene copolymers are used as the aminomethylphosphonic acid group-containing polymers.

3. The process as claimed in claim 1, wherein average degree of substitution of the aminomethyl groups by phosphonic acid groups in the aminomethylphosphonic acid group-containing polymers is 1.4 to 2.0.

4. The process as claimed in claim 1, wherein the base does not contain any potassium oxalate.

5. The process as claimed in claim 1, wherein particles of the polymer have a diameter (d₅₀) of 250 μm to 450 μm.

6. The process as claimed in claim 5, wherein at least 90% by volume or 90% by mass of the particles have a diameter within the interval of ±10% of the most common diameter.

7. The process as claimed in claim 1, wherein the eluting solution is an aqueous 6% by weight-12% by weight alkali metal hydroxide solution.

8. The process as claimed in claim 1, wherein aluminum ions are eluted.

9. The process as claimed in claim 1, wherein the aminomethylphosphonic acid group-containing polymer is a chelating resin containing functional groups of structural element (I) 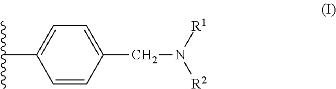
in which [symbol] is a polystyrene copolymer skeleton and
R¹ and R² may be identical or different and are independently —CH₂PO(OX¹)₂ and —CH₂PO(OH)OX² or hydrogen, where R¹ and R² may not both simultaneously be hydrogen and X¹ and X² are independently hydrogen, sodium, potassium or lithium.

10. A process for elution of aluminum ions and/or zinc ions, comprising the steps of,
a.) bringing into contact with an aqueous metal ion solution containing aluminum ions and/or zinc ions and optionally further metal ions, at least one chelating resin containing functional groups of structural element (I) 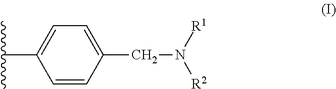
in which [symbol] is the polystyrene copolymer skeleton and
where R¹ and R² may not both simultaneously be hydrogen and X¹ and X² are independently hydrogen, sodium, potassium or lithium; and
b.) eluting the aluminum ions and/or zinc ions with an aqueous alkali metal hydroxide solution or/and an ammonium hydroxide solution.

11. The process as claimed in claim 10, wherein R¹ and R² may be identical or different and independently are —CH₂PO(OX¹)₂ and —CH₂PO(OH)OX².

12. The process as claimed in claim 11, wherein X¹ and X²=H.

13. The process as claimed in claim 10, wherein the aqueous metal ion solution contains aluminum ions, nickel ions and cobalt ions.

14. The process as claimed in claim 13, wherein the molar ratio of the aluminum ions to the nickel ions and the cobalt ions is 0.5 to 1.5.

15. The process as claimed in claim 10, wherein the aqueous metal ion solution has a pH of 1.5 to 6.0.
